(19) United States
(12) Patent Application Publication
(10) Pub. No.: US 2009/0171852 A1
(43) Pub. Date: Jul. 2, 2009

(54) Method and System for Providing Secure Processing of Electronic Transactions

(76) Inventors: Scott Taylor, Spring, TX (US); Annette Taylor, Spring, TX (US)

Correspondence Address: Jay M. Schloff;Intellipex PLLC, Suite 245, 30200 Telegraph Road, Bingham Farms, MI, 48025, US

(21) Appl. No.: 11/965,846

(22) Filed: Dec. 28, 2007

(51) Int. Cl. G06Q 20/00

(52) U.S. Cl. 705/76; 705/77; 705/79

(57) ABSTRACT

Disclosed is a method and system for providing secure processing of electronic transactions for customers. Each customer maintains at least one payment account for use in the electronic transactions. The method includes processing a first electronic transaction. The first electronic transaction is processed using a payment account of the at least one payment account. Further, the method includes generating a transaction code for the first electronic transaction that is capable of identifying the payment account used for processing the first electronic transaction. Furthermore, the method includes processing a second electronic transaction for the customer using the transaction code on selection of the payment account. A transaction code is generated for each electronic transaction subsequent to the first electronic transaction. Further, each transaction code is used to process an electronic transaction processed subsequent to the generation of the each transaction code on selection of the payment account by the customer.

### FIELD OF THE INVENTION

The present invention generally relates to electronic commerce, and, more particularly, to secure processing of electronic transactions.

### BACKGROUND OF THE INVENTION

Conducting business transactions over electronic means, also referred to as Electronic commerce (E-commerce), is increasingly being preferred by business owners for conducting day-to-day business transactions. E-commerce includes activities such as card based transactions, online transactions and electronic transfer of funds.

For making a purchase from a merchant's enterprise, a customer may present financial information, such as account number of a payment account to be used for payment, to the merchant at a point-of-sale (POS). The customer may provide the financial information to the merchant in form of an electronically readable card, an E-check, biometric data, and the like, for initiating an electronic transaction. The merchant's system communicates the financial information to a financial network via the Internet to process the electronic transaction. The financial network includes a network of financial institutions such as banks and credit card associations for authorizing the electronic transaction and initiating the transfer of funds from the customer's payment account to a merchant's account.

Typically, the financial information is provided by the customer to the merchant for each subsequent transaction between the customer and the merchant. The customer needs to provide the financial information to the merchant for each subsequent transaction, even for instances such as a customer revisiting the merchant's enterprise multiple times in a single day.

Also, furnishing the financial information for each transaction between the merchant and the customer, such as by providing an electronic card for each transaction, requires the customer to carry the electronic card for each transaction, exposing the customer to a higher risk of losing the electronic card.

The financial information provided by the customer may be stored by the merchant on the merchant's system for future customer transactions. Storing the customer's financial information on the merchant's system precludes the customer from providing the financial information for each subsequent transaction between the customer and the merchant. Storing the financial information, however, may lead to fraudulent use of the financial information. For instance, the financial information may be used to process unauthorized transactions. Further, the merchant must comply with various security standards for secure processing of electronic transactions and post-processing security laid down by various organizations, such as the Payment Card Industry (PCI), for storing the financial information of customers.

Further, the merchant incurs an increase in cost for processing electronic transactions, as the merchant is charged a transaction processing fee by the financial network for each processed electronic transaction. Furthermore, the merchant is liable to a transaction processing fee even when the electronic transaction results in an error due to reasons such as insufficient funds in the payment account, an expired account, and the like.

Accordingly, there exists a need for secure processing of electronic transactions. Further, there exists a need for precluding the customer from providing the financial information for each subsequent transaction between the customer and the merchant. There also exists a need for precluding storage of the customer's financial information on a merchant's system.

There also exists a need for secure processing of electronic transactions without performing extensive modifications to proprietary electronic transaction systems used by the merchants. Further, there exists a need for reducing transaction processing fees charged to the merchant by the financial network for processing the electronic transactions.

### SUMMARY OF THE INVENTION

An object of the present invention is to provide secure processing of electronic transactions.

Another object of the present invention is to preclude a customer from providing financial information for each subsequent electronic transaction between a merchant and the customer.

Yet another object of the present invention is to preclude storing of the financial information of the customer on a merchant's system.

Still another object of the present invention is to integrate secure processing of the electronic transactions into proprietary electronic transaction systems.

Yet another object of the present invention is to reduce transaction processing fees charged to the merchant by a financial network for processing the electronic transactions.

In view of the foregoing disadvantages inherent in the prior art, the general purpose of the present invention is to provide secure processing of electronic transactions that is configured to include all advantages of the prior art, and to overcome the drawbacks inherent therein. In an aspect of the present invention, a method is provided for secure processing of electronic transactions for customers. Each customer maintains at least one payment account for use in the electronic transactions. A first electronic transaction is processed using a payment account of the at least one payment account of the customer. A transaction code is generated for the first electronic transaction. The transaction code is capable of identifying the payment account used for processing the first electronic transaction. A second electronic transaction for the customer is processed using the generated transaction code.

The transaction code is used to process the second electronic transaction on selection of the payment account by the customer. A transaction code is generated for each electronic transaction subsequent to the first electronic transaction. Each transaction code is used to process an electronic transaction processed subsequent to the generation of the each transaction code on selection of the payment account by the customer. Processing electronic transactions using transaction codes provides secure processing of the electronic transactions. Further, using transaction codes for processing the electronic transactions precludes the need for the customer to provide financial information for each subsequent electronic transaction. Furthermore, the merchant may store only a transaction code generated for an electronic transaction for processing a subsequent electronic transaction, thereby precluding the need to store the financial information of the customer on the merchant's system.

The method also includes comparing the transaction codes for processed electronic transactions with payment gateway codes of settled transactions that are retrieved from a payment gateway for a match. The comparison permits the merchant to automatically reconcile the processed electronic transactions.

Further, each electronic transaction is associated with a transaction invoice. The method includes identifying transaction invoices for the each electronic transaction subsequent to the first electronic transaction. Further, the transaction invoices for the customer may be grouped into one transaction invoice and processed as one electronic transaction to reduce the transaction processing fees charged to the merchant by the financial network.

In another aspect of the present invention, a system is provided for secure processing of electronic transactions for customers. Each customer maintains at least one payment account for use in the electronic transactions. The system includes a data entry module, a network interface module and a code generator module. The data entry module is capable of receiving a selection of a payment account of the at least one payment account of a customer for processing an electronic transaction. The network interface module is configured to communicate with a payment gateway. Further, the network interface module is capable of receiving the selection of the payment account from the data entry module for communicating payment account information to the payment gateway. The code generator module is capable of communicating with the network interface module for generating a transaction code for each electronic transaction. The transaction code uniquely identifies the payment account used for processing the electronic transaction. Processing of electronic transactions using transaction codes provides secure processing of the electronic transactions. Further, the system may be easily integrated into existing proprietary systems for providing secure processing of the electronic transactions.

In yet another aspect of the present invention, a computer program product is embodied on a computer readable medium for providing secure processing of electronic transactions for customers. Each customer maintains at least one payment account for use in an electronic transaction. The computer program product includes a program module having instructions for processing a first electronic transaction for a customer. The first electronic transaction is processed using a payment account of the at least one payment account of the customer. A transaction code is generated for the first electronic transaction. The transaction code is capable of identifying the payment account used for processing the first electronic transaction. A second electronic transaction for the customer is processed using the generated transaction code. The transaction code is used to process the second electronic transaction on selection of the payment account by the customer. A transaction code is generated for each electronic transaction subsequent to the first electronic transaction. Each transaction code is used to process an electronic transaction processed subsequent to the generation of the each transaction code on selection of the payment account by the customer. Processing electronic transactions using transaction codes provides secure processing of the electronic transactions.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts an environment in which various embodiments of the present invention may be practiced;

FIG. 2 is a block diagram of a merchant site, in accordance with an embodiment of the present invention;

FIG. 3 is a flow diagram representing a method for secure processing of electronic transactions for customers, in accordance with an embodiment of the present invention;

FIG. 4 illustrates structure of a transaction code, in accordance with an embodiment of the present invention;

FIG. 5 is a flow diagram depicting an implementation of the method represented in FIG. 3 for processing various options offered by the method, according to an embodiment of the present invention; and

FIGS. 6-11 are flow diagrams representing the various options introduced in FIG. 5, according to various embodiments of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present invention provides a method, system and a computer program product for secure processing of electronic transactions for customers. Each customer maintains at least one payment account for use in the electronic transactions. A first electronic transaction is processed using a payment account of the at least one payment account of the customer. A transaction code is generated for the first electronic transaction. The transaction code is capable of identifying the payment account used for processing the first electronic transaction. A second electronic transaction for the customer is processed using the generated transaction code. The transaction code is used to process the second electronic transaction on selection of the payment account by the customer. A transaction code is generated for each electronic transaction subsequent to the first electronic transaction. Each transaction code is used to process an electronic transaction processed subsequent to the generation of the each transaction code on selection of the payment account by the customer. Processing electronic transactions using transaction codes provides secure processing of the electronic transactions.

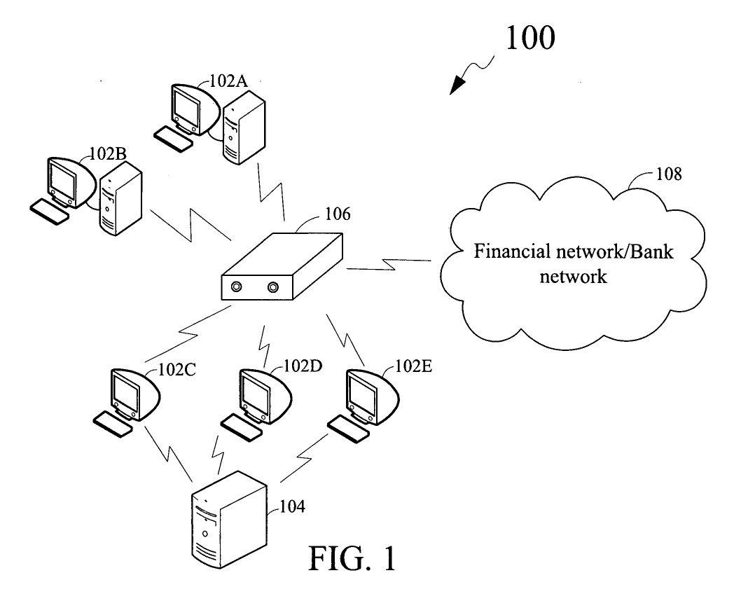

FIG. 1 depicts an environment 100 in which various embodiments of the present invention may be practiced. The environment 100 includes merchant sites such as a merchant site 102A, a merchant site 102B, a merchant site 102C, a merchant site 102D and a merchant site 102E, a database server 104, a payment gateway 106 and a financial network 108. The merchant sites 102A-102E are physical locations that are configured with electronic terminals for processing electronic transactions. For purpose of description of the present invention, the merchant sites 102A-102E refer to the electronic terminals configured at the physical locations. Examples of the electronic terminals may include but are not limited to a laptop, a personal computer, an electronic card processing device, or any combination thereof. Merchant sites such as the merchant sites 102A-102E store information such as records of customers. The merchant sites 102C-102E may be part of a chain of retail stores and may store the information in a common central database server, such as the database server 104. Each merchant site of the merchant sites 102A-102E will hereinafter be referred to as ‘merchant site 102’.

The merchant site 102 communicates with the financial network 108 through the payment gateway 106 for processing the electronic transactions. The financial network 108 includes a network of financial institutions such as banks, credit card associations, and the like. The banks included in the financial network 108 include acquiring banks and issuing banks. A merchant corresponding to the merchant site 102 maintains a merchant account with an acquiring bank of the acquiring banks present in the financial network 108. Customer payments for purchases made by the customers at the merchant site 102 are accepted by the acquiring bank on behalf of the merchant. Similarly, an issuing bank of the issuing banks maintains a payment account of a customer involved in an electronic transaction with the merchant site 102.

The card associations of the financial network 108 include credit card associations such as VISA, MasterCard, American Express, and the like. The card associations issue electronic cards to the customers and link the electronic cards to payment accounts of the customers in the issuing banks. The customer may choose to make a purchase at the merchant site 102 using an electronic card. The merchant site 102 may communicate information provided on the electronic card to the payment gateway 106 for authorizing the electronic transaction. The payment gateway 106, typically an e-commerce application service provider service, communicates the information to an issuing bank that holds a payment account linked to the electronic card, for authorization purposes. The payment gateway 106 communicates a response from the issuing bank back to the merchant site 102 which requested the authorization of the electronic transaction.

On receiving authorization, a payment amount corresponding to the purchase made by the customer may be transferred from the payment account of the customer in the issuing bank to the merchant account in an acquiring bank. It will be apparent to a person skilled in the art that the payment gateway 106 may be, for the purposes of the description, a data processing terminal at any remote physical location capable of facilitating transfer of financial information among merchants, customers, credit card associations, third party vendors or any other entity in the financial network 108. Further, the payment gateway 106 may be made up of a single node or multiple nodes for carrying out the electronic transactions.

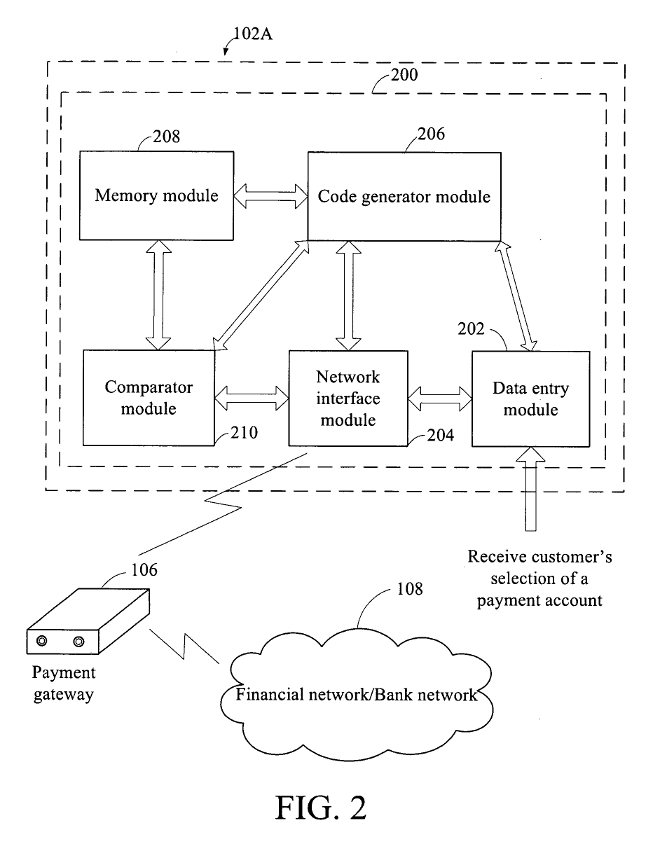

The merchant site 102 and the payment gateway 106 may communicate using at least one of: a wired network and a wireless network. Examples of the wired network may include but are not limited to a Local Area network (LAN) and a Metropolitan Area Network (MAN). An example of the wireless network may include a wireless Local area network (WLAN). It will be evident to those skilled in the art that sensitive financial information such as Credit card numbers, E-check account numbers, Automated Clearing House (ACH) account numbers are encrypted prior to transmission over the wired network or the wireless network for security purposes. Configuration of the merchant site 102 will be explained in detail in conjunction with FIG. 2.

FIG. 2 is a block diagram of the merchant site 102 of FIG. 1, in accordance with an embodiment of the present invention. For the purpose of description of FIG. 2, reference will be made to FIG. 1 described above. The merchant site 102 includes a system 200 for providing secure processing of electronic transactions to customers. The system 200 includes a data entry module 202, a network interface module 204, a code generator module 206, a memory module 208 and a comparator module 210. Each customer at the merchant site 102 maintains at least one payment account for use in the electronic transactions.

The data entry module 202 is capable of receiving a selection of a payment account of the at least one payment account of a customer for processing an electronic transaction. The network interface module 204 configured to communicate with the payment gateway 106 is capable of receiving the selection of the payment account from the data entry module 202 and communicating the payment account information to the payment gateway 106. The code generator module 206 is capable of communicating with the network interface module 204 for generating a transaction code for each electronic transaction. Each transaction code identifies the payment account used for processing the each electronic transaction and is used for processing an electronic transaction subsequent to the each electronic transaction, on selection of the payment account by the customer. The processing of the electronic transactions using transaction codes provides secure processing of the electronic transactions.

The data entry module 202 receives the selection of the payment account. Examples of the data entry module 202 may include a keyboard, a mouse, a joystick, a touch screen device and the like. In one embodiment of the present invention, the data entry module 202 is capable of receiving one of an electronic card and a biometric data associated with the payment account of the customer. Examples of the electronic card may include a debit card, a credit card, a smart card, and the like. The electronic card may be swiped in the data entry module 202, such as a card reader, for selecting the payment account of the customer. Examples of the biometric data of the customer may include, fingerprint recognition, voice recognition, iris recognition, face recognition, and the like. Further, the data entry module 202 may also be capable of receiving payment account information of the customer entered manually into the data entry module 202. In another embodiment, the data entry module 202 may be capable of receiving the selection of the payment account by the customer via an email sent by the customer. It will be apparent to a person skilled in the art that the data entry module 202 in this embodiment may be a software module or a firmware module with emailing capabilities. The network interface module 204 is communicably coupled to the data entry module 202 for receiving the selection of the payment account from the data entry module 202.

The network interface module 204 may communicate the payment account information of the customer to the payment gateway 106. Examples of the payment account information include, but are not limited to, a pre-determined number of digits of the payment account that is selected by the customer, payment gateway identification information, a type of the payment account such as a MasterCard account or a Visa account, and the like. The payment gateway identification information communicated by the network interface module 204 as a part of the payment account information identifies the payment gateway 106 in the financial network 108. In one embodiment of the present invention, the network interface module 204 includes a transmitter module (not shown) and a receiver module (not shown) for communicating with the payment gateway 106. Examples of the network interface module 204 include but are not limited to, a modem and a Network Interface Card (NIC).

The network interface module 204 is also configured to transmit various control signals to the payment gateway 106. Examples of the control signals include a control signal for authorization of an electronic transaction, a control signal for reversing a processed electronic transaction, a control signal for nullifying an electronic transaction and the like. The network interface module 204 is also capable of receiving payment gateway codes from the payment gateway 106. The payment gateway codes are generated by the payment gateway 106. Each payment gateway code uniquely identifies an electronic transaction processed through the payment gateway 106. A payment gateway code may include a pre-defined combination of digits or alpha-numeric characters. For example, the payment gateway code may include 9 digits. The code generator module 206 is communicably coupled to the network interface module 204 for receiving the payment gateway code received by the network interface module 204.

The code generator module 206 utilizes the payment gateway code received from the network interface module 204 to generate a transaction code. The transaction code generated by the code generator module 206 identifies the payment account selected by the customer for processing the electronic transaction. Though the code generator module 206 utilizes the payment gateway code for generating the transaction code, it will be evident to those skilled in the art that the code generator module 206 may generate the transaction code, identifying the payment account selected by the customer, without utilizing the payment gateway code. The transaction code is stored in the memory module 208 and is used for processing an electronic transaction subsequent to the electronic transaction. The code generator module 206 is capable of generating a transaction code for each electronic transaction. Each transaction code is used for processing an electronic transaction subsequent to the electronic transaction for which the transaction code is generated, on selection of the payment account by the customer.

The memory module 208 may also store other information related to an electronic transaction, such as customer identification information, date of processing the electronic transaction and the like in a record of the customer. In an embodiment, the customer identification information includes at least one of a customer name, a customer company name, and similar identification information. The memory module 208 is communicably coupled to the comparator module 210.

The comparator module 210 is configured to compare transaction codes stored in the memory module 208 with a list of payment gateway codes of settled transactions retrieved from the payment gateway 106 by the network interface module 204 for a match. The payment gateway codes of settled transactions refers to payment gateway codes for the electronic transactions for which payment amounts corresponding to the electronic transactions, have been transferred from payment accounts of the customers in the issuing banks to merchant accounts in the acquiring banks. The comparator module 210 is also capable of comparing a transaction code for an electronic transaction that needs to be reversed or nullified with the payment gateway codes of settled transactions retrieved from the payment gateway 106.

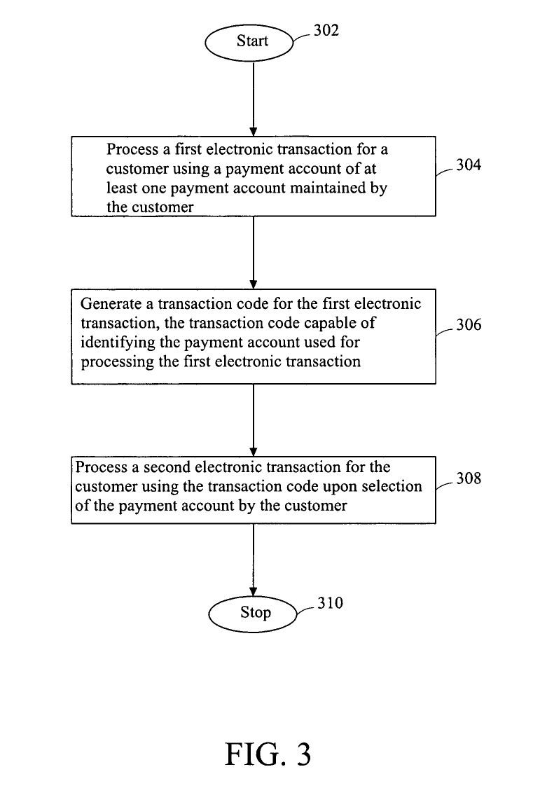

Further, the components of the system 200, such as the data entry module 202, the network interface module 204, the code generator module 206, the memory module 208 and the comparator module 210, may be implemented as hardware modules, software modules, firmware modules, or any combination thereof. Furthermore, it will be evident to those skilled in the art that the system 200 may include a microprocessor, a battery unit and an input/output (I/O) interface for performing typical functions of the merchant site 102. The system 200 is used to provide secure processing of the electronic transactions for customers. A method for providing secure processing of the electronic transactions for customers using the system 200 is explained in conjunction with FIG. 3.

FIG. 3 is a flow diagram representing a method for secure processing of electronic transactions for customers, in accordance with an embodiment of the present invention. Each customer maintains at least one payment account for use in the electronic transactions. The at least one payment account may be a credit card account, an E-check account, an Automated Clearing House (ACH) account, or any such type of account with electronic transaction processing capabilities. The method starts at 302. At 302, a customer at the merchant site 102 explained in conjunction with FIGS. 1 and 2, selects a payment account to be charged for a first electronic transaction. At 304, the first electronic transaction is processed for the customer using the selected payment account. At 306, a transaction code is generated for the first electronic transaction. The transaction code may be generated by the code generator module 206 of the system 200 at the merchant site 102. The transaction code is capable of identifying the payment account of the at least one payment account of the customer that was used for processing the first electronic transaction. The generated transaction code may be stored in the memory module 208.

At 308, a second electronic transaction is processed for the customer using the generated transaction code on selection of the payment account by the customer. The method ends at 310. At 310, the transaction code is generated for the second electronic transaction and is stored in the memory module 208 for use in processing a subsequent electronic transaction. The code generator module 206 generates a transaction code for each electronic transaction subsequent to the first electronic transaction between the customer and a merchant. The transaction code generated for an electronic transaction may be used to process an electronic transaction subsequent to the generation of the each transaction code on selection of the payment account by the customer. Processing the electronic transactions using transaction codes provides secure processing of the electronic transactions as it precludes storing of financial information of the customer at the merchant site 102.

For purposes of the present invention, the first electronic transaction refers to an electronic transaction that is processed using a payment account that has not previously been used by the customer for processing electronic transactions with the merchant. The customer may be visiting the merchant site 102 for a first time or the customer may be an existing customer using a payment account of the at least one payment account for a first time.

The customer visiting the merchant site 102 for the first time provides financial information, such as the electronic card linked to the customer account, along with the customer identification information to the merchant site 102. The customer identification information may be used to set up a record of the customer in the system 200. The record of the customer may be set up manually or by swiping an electronic card associated with the selected customer payment account or automatically using accounting software integrated with the system 200. If the customer is an existing customer, then the customer identification information for the customer already exists in the memory module 208 and is accessible at the merchant site 102. As explained in conjunction with FIG. 2, the customer identification information may be at least one of a customer name, a customer company name, and similar identification information. The generated transaction code may be stored with the record of the customer in the memory module 208 using the customer identification information. The system 200 may receive the customer identification information from the customer for identifying the customer prior to processing each electronic transaction subsequent to the first electronic transaction using the payment account.

For processing the electronic transactions using the payment account, the customer does not need to provide the electronic card for the subsequent electronic transactions. Providing the merchant site 102 with the customer identification information and the selection of the payment account, the subsequent electronic transactions may be processed. For processing an electronic transaction with a new payment account, the electronic transaction is treated as the first electronic transaction, and a transaction code identifying the new payment account is stored. A subsequent electronic transaction using the new payment account is processed using the transaction code that identifies the new payment account.

In one embodiment of the present invention, the customer identification information is grouped based on the customer company name. When the customer needs to process an electronic transaction, the customer is identified using the customer name and the customer company name provided by the customer. The record of the customer may be identified with the customer name and linked with the customer company name. It will be evident to a person skilled in the art, that the customer identification information may be stored to uniquely identify each customer. Additionally, the customer company name may have an associated Employer Personal Identification Number (EPIN) associated with it for ensuring security of the customer identification information in the memory module 208. The EPIN known to the customer may be presented with the customer identification information to retrieve the record of the customer from the memory module 208.

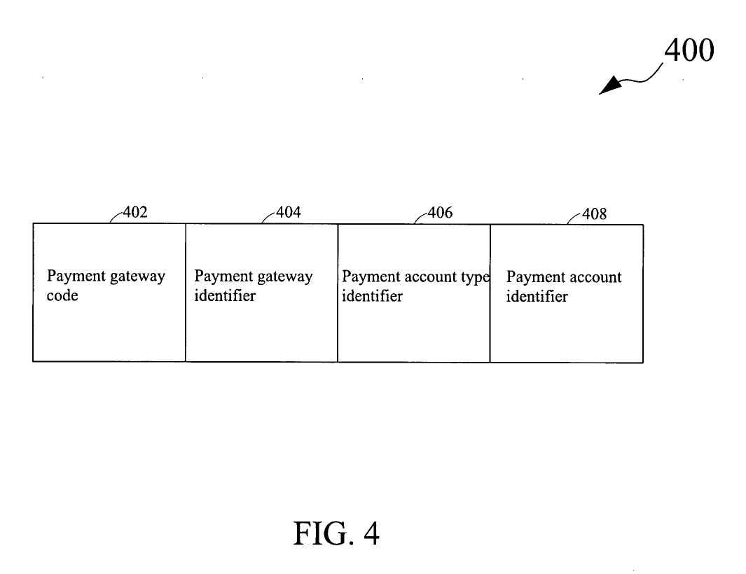

The transaction codes stored in the system 200 at the merchant site 102 preclude risk of storing of the financial information of the customer at the merchant site 102. The transaction codes are explained in more detail in FIG. 4.

FIG. 4 illustrates structure of a transaction code 400, in accordance with an exemplary embodiment of the present invention. The transaction code 400 uniquely identifies a payment account selected by a customer for processing an electronic transaction. As explained in conjunction with FIG. 2, the code generator module 206 generates a transaction code, such as, the transaction code 400 for each electronic transaction at the merchant site 102. The transaction code 400 includes a payment gateway code field 402, a payment gateway identifier field 404, a payment account type identifier field 406 and a payment account identifier field 408.

As explained in conjunction with FIG. 2, the payment gateway 106 generates a payment gateway code for the each electronic transaction processed through the payment gateway 106. The payment gateway code is transmitted to the system 200 and received by the system 200 using the network interface module 204. The code generator module 206 generates the transaction code 400 using the payment gateway code. The payment gateway code field 402 includes the payment gateway code for the electronic transaction processed by the payment gateway 106. An example of the payment gateway code may be 505256589, a number generated by the payment gateway 106 for uniquely identifying the electronic transaction.

It will be apparent to a person ordinarily skilled in the art that the payment gateway code may be formed by alphanumeric characters or any other combination, to generate the payment gateway code. Those skilled in the art will recognize that payment gateways, such as the payment gateway 106, may use different mechanisms for generating unique payment gateway codes. For instance, a payment gateway code generated by a first payment gateway may include alphanumeric characters, whereas a payment gateway code generated by a second payment gateway may include only numeric characters.

The payment gateway identifier field 404 of the transaction code 400 identifies the payment gateway 106 used for processing an electronic transaction associated with the transaction code 400. The payment gateway identifier field 404 may include a letter such as a letter ‘U’, numeric characters, or any combination of alphanumeric characters to identify the payment gateway 106.

The payment account type identifier field 406 includes information for identifying the type of payment account used for processing the electronic transaction. Examples of the type of payment account include a MasterCard account, a Visa account, an E-check account, an ACH account and the like. The type of payment account may be identified by a letter (for example, ‘M’, to identify the payment account as a MasterCard account), a numeric entry or alphanumeric characters.

The payment account identifier field 408 includes information for identifying the payment account used for processing the electronic transaction. For instance, the payment account identifier field 408 may include a pre-determined number of digits of the payment account used for processing the electronic transaction. In one embodiment of the present invention, last three digits of the payment account used for processing the electronic transaction are included in the payment account identifier field 408.

An example of the transaction code 400 generated by the system 200 is ‘505256589UM319’. The payment gateway code field 402 is represented by the digits ‘505256589’, which uniquely identifies the electronic transaction processed by the payment gateway 106. The payment gateway identifier field 404 is represented by the alphabet ‘U’, identifying the payment gateway 106 through which the electronic transaction was processed. The payment account type identifier field 406 is represented by ‘M’, identifying the payment account as a MasterCard account. The payment account identifier field 408 is represented by ‘319’ identifying the last three digits of the payment account used for processing the electronic transaction. It will be apparent to a person ordinarily skilled in the art that the transaction code 400 may be generated using any other combinations of the above mentioned fields; or, alternatively, the transaction code 400 may be generated using other fields which may be obvious extensions of the above mentioned fields.

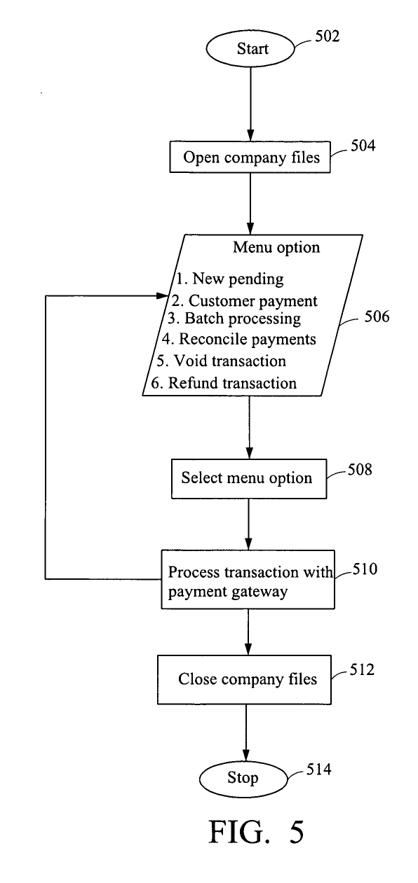

FIG. 5 is a flow diagram illustrating a method for processing an electronic transaction at the merchant site 102 explained in conjunction with FIGS. 1 and 2, in accordance with an embodiment of the present invention. The merchant site 102 includes the system 200. The various modules of the system 200, such as the code generator module 206 may be implemented as software application at the merchant site 102 using programming languages such as Microsoft VisualBasic.Net, Microsoft ASP.Net, Extensible Markup Language (XML), Simple Object Access Protocol (SOAP), Web Services Description Language (WSDL), XML Schema Definition (XSD), Microsoft Visual C++.Net, and the like.

In addition to the system 200, the merchant site 102 also includes typical accounting software used for processing electronic transactions. Examples of typical accounting software include QuickBooks, Simply Accounting, Peachtree Accounting, and the like. The accounting software is computer software used for recording and processing accounting transactions such as the electronic transactions and cash-payment transactions. The accounting transactions may be recorded and processed within various modules of the accounting software, such as accounts payable module, accounts receivable module, payroll module, and the like.

The accounting software is further capable of generating transaction invoices for processing the electronic transactions, as well as, for processing the cash-payment transactions. The various modules of the system 200 may be integrated with the accounting software included at the merchant site 102 using standard middleware. It will be evident to a person ordinarily skilled in the art that middleware is a computer software used for connecting software components or applications based on XML, SOAP, Web services, and service-oriented architecture. Examples of middleware include Object Database Connectivity (ODBC), Common Object Request Broker Architecture (CORBA), Distributed Component Object Model (DCOM), Java Database Connectivity (JDBC), enterprise application integration software, and the like.

The system 200 may further require standard library files used by the accounting software for integrating with the accounting software. For example, if the accounting software has been implemented using QuickBooks, then the system 200 may need to utilize QuickBooks Foundation Class Library (QFCL) for integrating with the accounting software. The system 200 may use the QFCL during implementation, to establish a connection and initiate a communication session with QuickBooks accounting software.

The method initiates at 502. At 502, the system 200 initiates a connection with the accounting software for processing the electronic transactions for customers. Based on goods or services purchased by a customer, the accounting software generates a transaction invoice for the customer. The system 200 identifies transaction invoices for each electronic transaction subsequent to the first electronic transaction before processing the each electronic transaction for the customer. Each transaction invoice of the transaction invoices is associated with an electronic transaction of the each electronic transaction. The system 200 may uniquely identify the each transaction invoice for a customer by using unique codes or markers. For example, the each transaction invoice generated by the accounting software may be identified by the system 200 by associating the customer identification information of the customer with the each transaction invoice.

As described in conjunction with FIG. 3, the customer may be an existing customer or a first time customer at the merchant site 102. In order to process the electronic transaction, the customer provides customer identification information along with details of a payment account to be used for processing the electronic transaction. For the first time customer, the customer identification information such as a customer name and a customer company name provided by the customer may be stored in the memory module 208 of the system 200, as described in conjunction with FIG. 2. The customer identification information for the customers may further be grouped depending on the customer company name. For accessing information for the customer, a file of the customer company name may be opened and a relevant record corresponding to the customer may be retrieved. At 504, a company file open event retrieves a record corresponding to the customer.

At 506, for each retrieved record of the customer, the system 200 is configured to display various menu options for processing the electronic transactions for the customer. In one embodiment of the present invention, the menu options displayed may include new pending menu option, customer payment menu option, batch processing menu option, reconcile payments menu option, void transaction menu option and refund transaction menu option. Alternatively in another embodiment of the present invention, the system 200 may automatically launch the new pending menu option or the customer payment menu option upon receiving the customer identification information. For an existing customer using a payment account for which a transaction code is present in the memory module 208, the system 200 automatically launches the customer payment menu option upon selection of the payment account by the customer. For a payment account not used previously for processing electronic transactions with the merchant, the system 200 automatically launches the new pending menu option upon entering the financial information of the payment account. Further, it will be obvious to a person skilled in the art that the system 200 may be configured to include menu options for performing traffic analysis, generating reports and similar functional menu options.

At 508, a merchant at the merchant site 102 selects the menu option from the displayed menu options. The merchant may indicate his selection of the menu option by using the data entry module 202 of the system 200, as described in conjunction with FIG. 2. At 510, the electronic transaction is processed with the payment gateway 106 in accordance with the menu option selected by the merchant.

At 512, a company file close event closes the company file corresponding to the customer company name. The method stops at 514. At 514, a company file corresponding to a new customer may be opened by using the company file open event or the connection with the accounting software may be terminated.

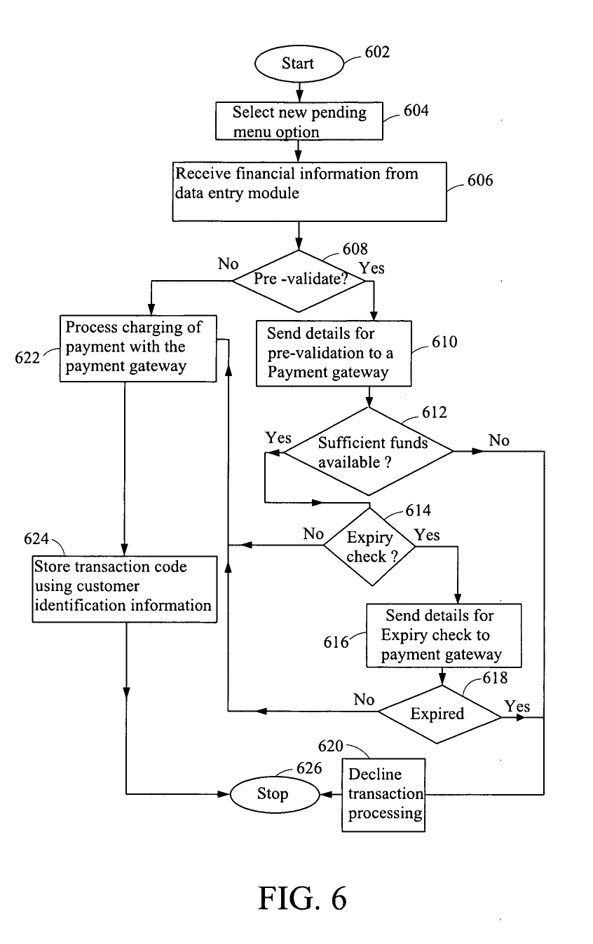

The menu options for processing the electronic transactions are explained in detail in conjunction with FIGS. 6-11.

FIG. 6 is a flow diagram illustrating a method for processing an electronic transaction on selection of the new pending menu option, in accordance with an embodiment of the present invention. As explained in conjunction with FIG. 5, the new pending menu option is displayed by the system 200 for each retrieved record of a customer. The new pending menu option may be selected by a merchant for processing a first electronic transaction when the customer is a first-time customer to the merchant's enterprise. The new pending menu option may also be selected by the merchant for processing the first electronic transaction for an existing customer using a payment account not previously used by the customer for processing electronic transactions with the merchant.

The method starts at 602 with the system 200 displaying the various menu options as described in conjunction with FIG. 5. For the first-time customer, the merchant requests customer identification information such as a customer name or a customer company name for storing in the memory module 208, as explained in conjunction with FIG. 3. The customer identification information may be retrieved for processing subsequent electronic transactions for the customer. For the existing customer using a new payment account not previously used by the existing customer for processing the electronic transactions with the merchant, the merchant may set up a new record for the new payment account used by the existing customer in the record of the customer. The new record may be manually set-up or may be set-up automatically by the accounting software.

At 604, the merchant selects the new pending menu option for processing the first electronic transaction for the customer. At 606, the merchant receives financial information from the customer indicating the payment account to be charged for the electronic transaction. The financial information may be provided in form of an electronic card such as a credit-card. The merchant may enter the financial information into the system 200 using the data entry module 202. As explained in conjunction with FIG. 2, the data entry module 202 may include an electronic card reader, and the electronic card may be swiped in the electronic card reader for entering the financial information into the system 200. In an embodiment, as explained in FIG. 5, the system 200 may automatically launch the new pending menu option when the financial information of a payment account is received by the data entry module 202. The system 200 may automatically launch the new pending menu option by processing from 606 (without executing 602 and 604) upon entering the financial information of the payment account maintained by the customer.

The merchant may choose to pre-validate the payment account at 608. Pre-validating the payment account confirms validity of the payment account for processing the first electronic transaction and may save the merchant processing fee in case of invalid payment accounts. On choosing to pre-validate the payment account, the merchant may send the payment account details to the payment gateway 106, for pre-validating the payment account. At 610, the merchant sends the payment account details to the payment gateway 106. At 612, the payment gateway 106 communicates with an issuing bank linked to the payment account of the customer to check whether sufficient funds are available in the payment account for processing the first electronic transaction. For instance, in case of an electronic card such as a credit card, the payment gateway 106 may communicate with a credit-card issuing authority to check available credit limit of the credit card for processing the first electronic transaction. If the sufficient funds are available, the merchant may choose to check expiration details of the payment account at 614.

On choosing to check expiration details, the merchant may send the payment account details to the payment gateway 106 for checking the expiration details of the payment account. At 616, the merchant sends the payment account details to the payment gateway 106. The payment gateway 106 communicates expiration status of the payment account to the system 200. At 618, the system 200 checks if the payment account of the customer has expired. If the sufficient funds are not available or if the payment account used for processing the first electronic transaction has expired, the merchant declines processing of the first electronic transaction at 620. The customer may then choose another payment account for processing the first electronic transaction or choose to make payment using cash-based transaction.

If sufficient funds are available in the payment account or the payment account has not expired then the merchant may choose to process the first electronic transaction. At 622, the first electronic transaction is processed using the payment gateway 106. The merchant may also choose not to pre-validate the payment account and process the first electronic transaction using the payment gateway 106. The merchant processes charging of the payment amount by transmitting the financial information of the payment account to the payment gateway 106. The payment gateway 106 communicates with the issuing bank associated with the payment account for authorizing the first electronic transaction. If the first electronic transaction is authorized, the payment gateway 106 generates a payment gateway code that uniquely identifies the first electronic transaction. If the first electronic transaction is not authorized by the issuing bank, the issuing bank notifies reasons for rejection to the payment gateway 106. Accordingly, the payment gateway 106 may generate an error code recognizable by the system 200. The payment gateway 106 may then transmit the error code or the payment gateway code to the system 200.

For the payment gateway code received by the system 200 from the payment gateway 106, the system 200 generates a transaction code. The transaction code is generated in a format including the payment gateway code field 402, the payment gateway identifier field 404, the payment account type identifier field 406 and the payment account identifier field 408, as described in conjunction with FIG. 4. At 624, the generated transaction code is stored in the system 200 for processing a second electronic transaction, as described in conjunction with FIG. 3. The transaction code generated is stored in the memory module 208 and linked with the customer identification information including one of the customer name and the customer company name of the customer. For subsequent electronic transactions using the payment account, the customer may provide the customer identification information and the selection of the payment account instead of the financial information for processing the electronic transactions.

On processing the first electronic transaction and storing the transaction code generated for the first electronic transaction the method ends at 626. The method may also be terminated at 626 if the payment account has insufficient funds or if the payment account has expired.

It will be evident to those skilled in the art, that the payment account may be pre-validated using a variety of ways. For instance, in case of the financial information provided in the form of an E-check account number or an ACH account number, the payment gateway 106 may communicate with banks associated with corresponding accounts to perform checks for funds available for processing the first electronic transaction and expiration check.

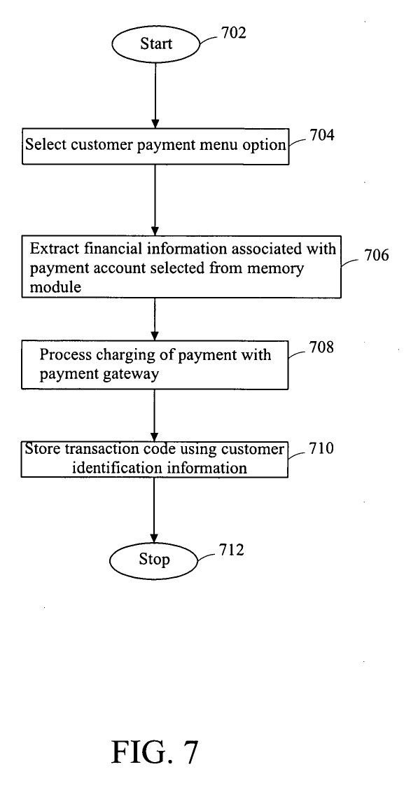

FIG. 7 is a flow diagram illustrating a method for processing an electronic transaction on selection of the customer payment menu option, in accordance with an embodiment of the present invention. As explained in conjunction with FIG. 5, the customer payment menu option is displayed by the system 200 for each retrieved record of a customer. A merchant may select the customer payment menu option for processing the electronic transaction for an existing customer by using the payment account used for processing a first electronic transaction. On selection of the payment account by the customer, the customer payment menu option may be selected by the merchant for processing the electronic transaction subsequent to the first electronic transaction.

The customer is an existing customer, and a transaction code for a previous electronic transaction is stored in the memory module 208 corresponding to the customer identification information. The customer provides the customer identification information along with the selection of the payment account for processing the electronic transaction. Using the customer identification information, such as a customer name or a customer company name, the merchant opens a record of the customer for obtaining the transaction code generated for the previous transaction. Alternatively, the system 200 automatically retrieves the financial information of the payment account from the record of the customer in the memory module 208 for processing the electronic transaction.

The method starts at 702 with the display of the various menu options as described in conjunction with FIG. 5. At 704, the customer payment menu option is selected by the merchant to process the electronic transaction for the customer. For the customer payment menu option, the customer selects a payment account to be used for processing the electronic transaction. The financial information of the payment account selected by the customer is extracted from a transaction code stored in the memory module 208. The transaction code corresponds to an electronic transaction previously processed by the customer using the payment account.

As explained in conjunction with FIG. 4, the transaction code includes information such as the payment account identifier and the payment gateway identifier. The system 200 is configured to extract the financial information corresponding to the payment account from the transaction code and send the information for identifying the payment account to the payment gateway 106 identified with the payment gateway identifier field 404 of the transaction code for processing the electronic transaction. At 706, the system 200 extracts the financial information associated with the payment account selected, from the transaction code stored in the memory module 208. In an embodiment, as explained in FIG. 5, the system 200 may automatically launch the customer payment menu option when the customer identification information and selection of the payment account of a customer is received by the data entry module 202. The system 200 may automatically launch the customer payment menu option by processing from 706 (without executing 702 and 704) upon entering the customer identification information and selected payment account of the customer for processing the electronic transaction.

At 708, the system 200 processes charging of the electronic transaction by transmitting the financial information to the payment gateway 106. As explained in conjunction with FIG. 6, the payment gateway 106 communicates with an issuing bank associated with the payment account for authorizing the electronic transaction and generates a payment gateway code or an error code. For an authorized payment, the payment gateway code is transmitted to the system 200, which then generates a transaction code for processing the electronic transaction. At 710, the system 200 stores the transaction code in the memory module 208 for use in processing a subsequent electronic transaction. The method terminates at 712, with the transaction code for the electronic transaction stored in the memory module 208.

It will be apparent to a person ordinarily skilled in the art that the merchant may chose to pre-validate the payment account before processing the electronic transaction using procedure for pre-validating the payment account as explained in conjunction with FIG. 6.

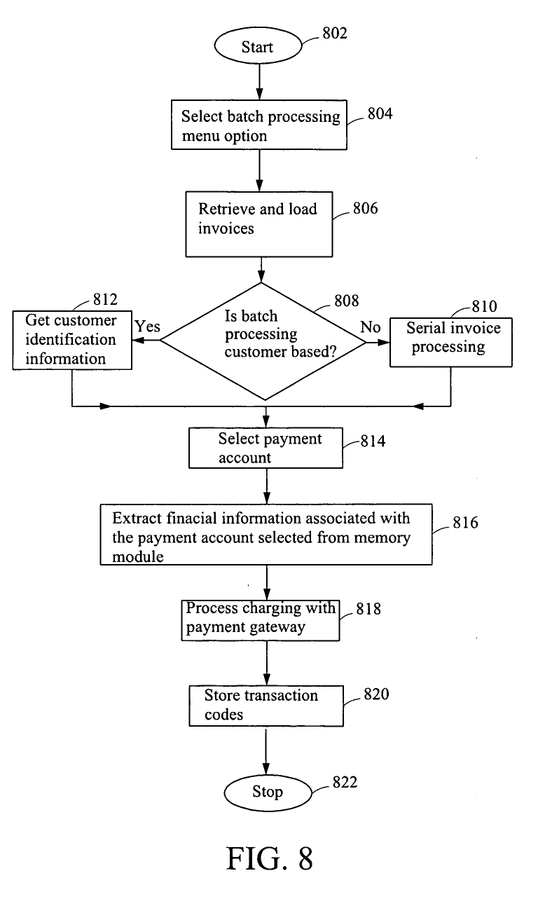

FIG. 8 is a flow diagram illustrating a method for processing electronic transactions on selection of the batch processing menu option, in accordance with an embodiment of the present invention. As explained in conjunction with FIG. 5, the batch processing menu option is displayed by the system 200 for each retrieved record of a customer. The batch processing menu option may be selected by a merchant when the merchant wants to process transaction invoices together in a batch.

As explained in conjunction with FIG. 5, the accounting software in communication with the system 200 generates transaction invoices for each electronic transaction processed by the system 200. A transaction invoice for the electronic transaction is generated prior to processing the electronic transaction by transmitting the financial information to the payment gateway 106. The merchant may choose to process the transaction invoices in a batch (as will be explained herein with reference to FIG. 8) or on a customer-to-customer basis as explained in conjunction with FIGS. 6 and 7. Existing customers may indicate selections of payment accounts for processing their respective electronic transactions to the merchant. The merchant may process the electronic transactions for a batch of the existing customers at a later point of time using transaction codes generated for previous transactions using the selected payment accounts, for the respective customers.

The method starts at 802 with the system 200 displaying the various menu options as described in conjunction with FIG. 5. At 804, the batch processing menu option is selected by the merchant to process the electronic transactions for the customers.

At 806, the system 200 retrieves the transaction invoices identified for the customers from the accounting software. In one embodiment of the present invention, the system 200 loads the transaction invoices for viewing by the merchant. At 808, the merchant chooses between performing a customer based batch processing and a serial invoice processing. In the customer based batch processing, the transaction invoices for a particular customer may be grouped into one transaction invoice prior to processing each electronic transaction subsequent to the first electronic transaction for the customer. In the serial invoice processing, the merchant may select the transaction invoices generated within a defined time period, such as one business day, for processing the electronic transactions for the customers in a batch. Alternatively, in the serial invoice processing, the merchant may select the transaction invoices based on transaction invoice number range.

At 810, the merchant selects the serial invoice processing option and may input the time period for retrieving the transaction invoices generated within the defined time period for processing the electronic transactions. Alternatively, the merchant may input a transaction invoice number range to retrieve transaction invoices generated. For example, the merchant may want to retrieve the transaction invoices that are numbered from 50 to 150. Alternatively, the merchant may select the customer based batch processing option. At 812, the merchant selects the customer based batch processing option and inputs the customer identification information, such as, the customer name and the customer company name to obtain the transaction invoices for the customer from the accounting software.

At 814, the merchant selects the payment account as indicated by the customer. The selection of the payment account indicated by the customer may be stored by linking a transaction invoice corresponding to the electronic transaction to be processed for the customer, with the transaction code generated for a previous electronic transaction between the merchant and the customer. At 816, the system 200 extracts the financial information associated with the payment account selected using the transaction code stored in the memory module 208, as explained in conjunction with FIG. 7.

At 818, the system 200 processes charging of the electronic transactions by transmitting the financial information to the payment gateway 106. As explained in conjunction with FIG. 6, the payment gateway 106 communicates with issuing banks associated with payment accounts of the customers for authorizing the electronic transactions and generates payment gateway codes or error codes for each of the electronic transactions processed in the batch. For authorized payments, the payment gateway codes are transmitted to the system 200, which then generates transaction codes for the processed electronic transactions. At 820, the system 200 stores the transaction codes for the processed electronic transactions in the memory module 208 for use in processing subsequent electronic transactions. The method terminates at 822, with the transaction codes for the electronic transactions stored in the memory module 208.

It will be apparent to a person ordinarily skilled in the art that the merchant may chose to pre-validate a payment account before processing the electronic transaction using procedure for pre-validating the payment account as explained in conjunction with FIG. 6.

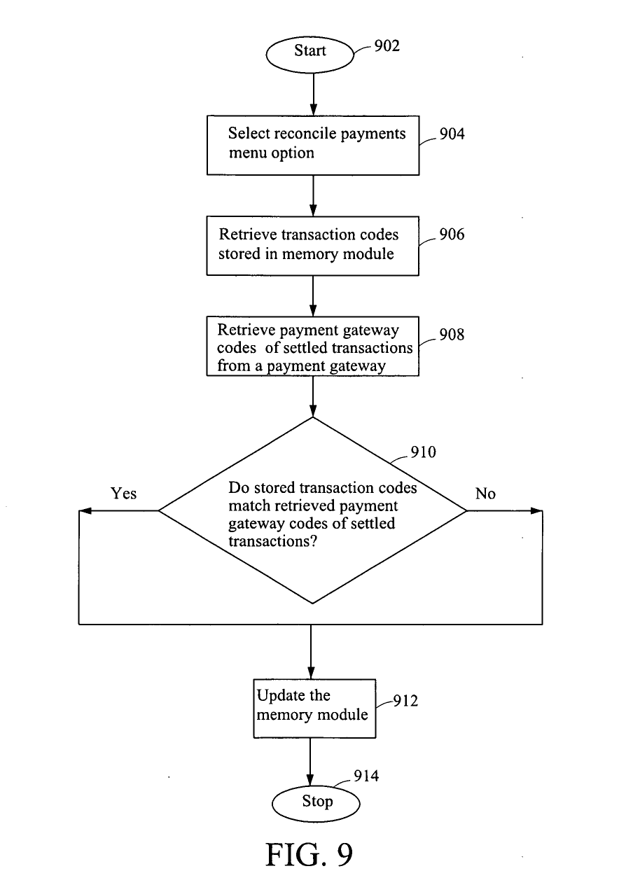

FIG. 9 is a flow diagram illustrating a method for reconciling payments for settled transactions on selection of the reconcile payments menu option, in accordance with an exemplary embodiment of the present invention. A settled transaction refers to a processed electronic transaction for which payment amount corresponding to an electronic transaction has been transferred from a payment account of a customer in an issuing bank to a merchant account in an acquiring bank. An unsettled transaction refers to a processed electronic transaction for which the payment amount corresponding to an electronic transaction has not yet been transferred from the payment account of the customer in an issuing bank to the merchant account in an acquiring bank. As explained in conjunction with FIG. 2, the payment gateway 106 generates payment gateway codes. The payment gateway 106 maintains a list of payment gateway codes for settled transactions as well as a list of payment gateway codes for unsettled transactions. Further, the list of payment gateway codes of settled transactions may be retrieved from the payment gateway 106 using the network interface module 204.

The method starts at 902 with the display of the various menu options as described in conjunction with FIG. 5. At 904, the reconcile payments menu option is selected by a merchant. At 906, the system 200 retrieves transaction codes stored in the memory module 208. At 908, the system 200 retrieves the list of payment gateway codes of settled transactions from the payment gateway 106. As explained in conjunction with FIG. 2, the system 200 may transmit a control signal to the payment gateway 106 for retrieving the list of payment gateway codes of settled transactions. The system 200 may transmit range of dates within which all payment gateway codes corresponding to settled transactions may be retrieved. For example, the merchant may want to retrieve the list of payment gateway codes for electronic transactions that have been settled in the first week of January 2007.

At 910, the system 200 compares the stored transaction codes with the list of payment gateway codes of settled transactions retrieved from the payment gateway 106 for a match. More specifically, the payment gateway code field 402 of each of the transaction codes is compared with each entry in the retrieved list of payment gateway codes of settled transactions for a match. For example, a value ‘505256589’ in the payment gateway code field 402 of the transaction code ‘505256589UM319’ may be compared with the list of payment gateway codes of settled transactions for matching by the comparator module 210.

For each transaction code that matches with an entry in the list of payment gateway codes of settled transactions, the memory module 208 is updated to reflect a settled transaction for an electronic transaction corresponding to the each transaction code. For each transaction code having no corresponding match in the list of payment gateway codes of settled transactions, the memory module 208 is updated to reflect an unsettled transaction for an electronic transaction corresponding to the each transaction code. At 912, the system 200 updates the memory module 208 with results of the comparison. Payment amounts corresponding to the settled transactions and unsettled transactions may be accordingly updated in the accounting software integrated with the system 200 to reconcile the merchant's balance sheet to match the actual amount of money transferred into the merchant account. The method terminates on reconciliation of payments for the electronic transactions at 914.

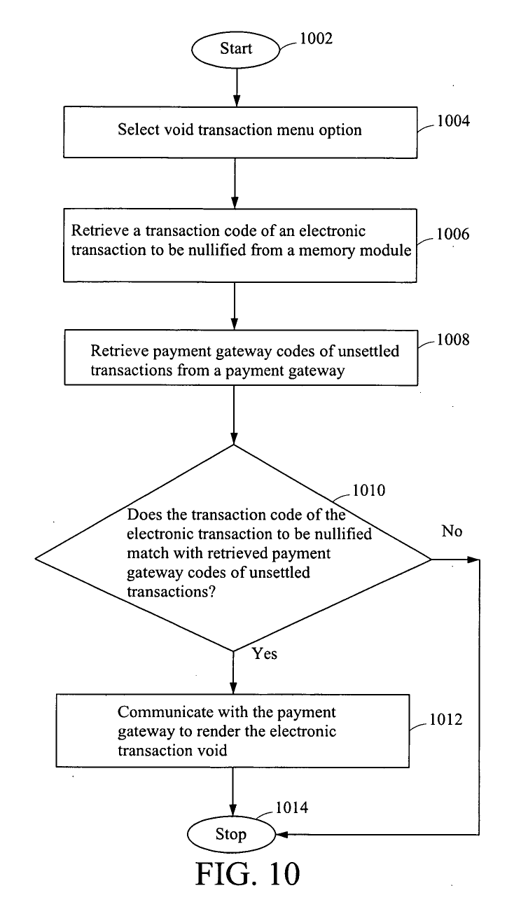

FIG. 10 is a flow diagram illustrating a method for rendering an electronic transaction void on selection of the void transaction menu option, in accordance with an exemplary embodiment of the present invention. As explained in conjunction with FIG. 5, the void transaction menu option is displayed by the system 200 for each retrieved record of a customer. The void transaction menu option may be selected by a merchant for nullifying an electronic transaction that has been processed for the customer. The electronic transaction may need to be nullified for a variety of reasons such as, for instance, an error in entering payment amount to be charged to the customer. Unsettled transactions or processed electronic transactions, for which the payment amounts have not been transferred into a merchant account, may be nullified by the merchant. The system 200 may send a control signal to the payment gateway 106 for nullifying the electronic transaction. The payment gateway 106 may then cancel the transfer of the payment amount from the payment account of the customer to the merchant account in the acquiring bank.

The method starts at 1002 with the system 200 displaying the various menu options as described in conjunction with FIG. 5. At 1004, the void transaction menu option is selected by the merchant. At 1006, the system 200 retrieves the transaction code of the electronic transaction to be nullified from the memory module 208. At 1008, the system 200 retrieves the list of payment gateway codes of unsettled transactions from the payment gateway 106. As explained in conjunction with FIG. 9, the list of payment gateway codes for unsettled transactions may be retrieved by transmitting range of dates within which all payment gateway codes corresponding to unsettled transactions may be retrieved.

At 1010, the system 200 compares the transaction code of the electronic transaction to be nullified with the retrieved list of payment gateway codes of unsettled transactions for a match. More specifically, the payment gateway code field 402 of the transaction code is compared with each entry in the retrieved list of payment gateway codes of unsettled transactions for a match.

On occurrence of a match, the system 200 may transmit the payment gateway code extracted from the transaction code of the electronic transaction to be nullified, to the payment gateway 106. In one embodiment of the present invention, the system 200 may also communicate a control signal authorizing the payment gateway 106 for nullifying a charge made to the payment account of the customer. At 1012, the system 200 communicates with the payment gateway 106 for rendering the electronic transaction void. The method terminates at 1014 with the electronic transaction rendered void.

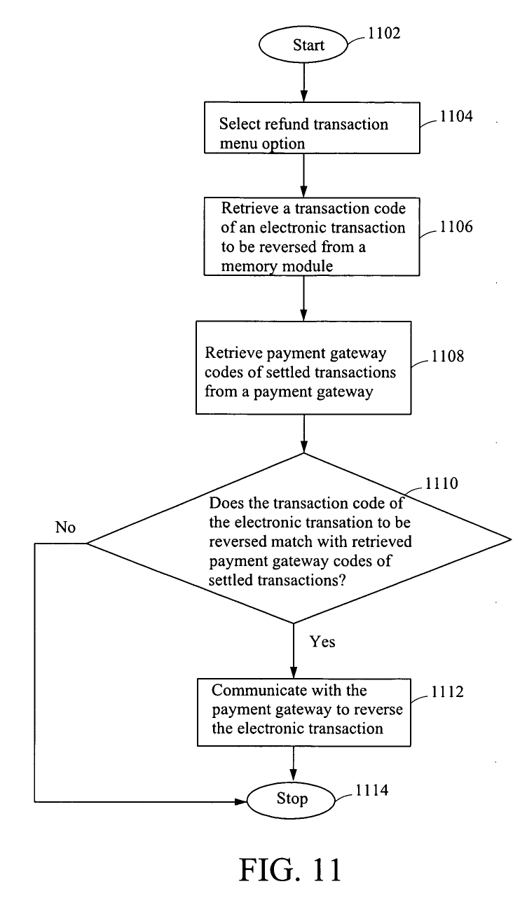

Alternatively, when the payment gateway code field 402 of the transaction code does not match a payment gateway code from the retrieved list of payment gateway codes of unsettled transactions, the merchant may need to perform the refund process to transfer the payment amount of the electronic transaction into the payment account of the customer. The refund process menu option is explained in more detail in conjunction with FIG. 11.

FIG. 11 is a flow diagram illustrating a method for reversing an electronic transaction on selection of the refund transaction menu option, in accordance with an exemplary embodiment of the present invention. As explained in conjunction with FIG. 5, the refund transaction menu option is displayed by the system 200 for each retrieved record of a customer.

The refund transaction menu option may be selected by a merchant for initiating a refund process to reverse an electronic transaction that has been processed for the customer. The merchant may need to reverse the electronic transaction for instances such as a returned purchase by the customer. The customer may return the purchase for a variety of reasons such as a defect in a product bought at the merchant's enterprise or incompatibility of the bought product with existing equipment at the customer's site and the like. The customer may present the transaction invoice corresponding to the electronic transaction that has been processed, to the merchant in order to initiate the refund transaction menu option for the processed electronic transaction. Settled transactions or processed electronic transactions for which payment amounts have been transferred into a merchant account of the merchant may be refunded by the merchant. The merchant may refund entire payment amount of a processed electronic transaction or a partial amount of the payment amount of the processed electronic transaction. The system 200 may send a control signal to the payment gateway 106 for initiating transfer of funds from the merchant account to the payment account of the customer. The payment gateway 106 may then communicate with an acquiring bank associated with the merchant account for initiating the transfer of funds.

The method starts at 1102 with the system 200 displaying the various menu options as described in conjunction with FIG. 5. At 1104, the refund transaction menu option is selected by the merchant. At 1106, the system 200 retrieves the transaction code of the electronic transaction to be reversed from the memory module 208. At 1108, the system 200 retrieves the list of payment gateway codes of settled transactions from the payment gateway 106. As explained in conjunction with FIG. 9, the list of payment gateway codes for settled transactions may be retrieved by transmitting range of dates to the payment gateway 106.

At 1110, the system 200 compares the transaction code of the electronic transaction to be reversed with the retrieved list of payment gateway codes of settled transactions for a match. More specifically, the payment gateway code field 402 of the transaction code is compared with each entry in the retrieved list of payment gateway codes of settled transactions for a match.

On occurrence of a match, the system 200 may transmit a control signal to the payment gateway 106, for reversing a charge made to the payment account of the customer. At 1112, the system 200 communicates with the payment gateway 106 to reverse the electronic transaction for refunding the payment amount charged to the customer. As mentioned previously, the merchant may refund entire payment amount or a partial amount of the payment amount charged to the customer for the electronic transaction to be reversed.

Alternatively, when the payment gateway code field 402 of the transaction code does not match a payment gateway code from the retrieved list of payment gateway codes of settled transactions, the merchant may need to void the electronic transaction as explained in conjunction with FIG. 10. The method terminates at 1114 with the electronic transaction reversed and the transfer of funds from the merchant account to the payment account of the customer initiated.

Processing of electronic transactions as implemented by a system, such as the system 200 of the present invention, is advantageous for providing security to the electronic transactions that are processed by customers, by precluding a need to store sensitive financial information of the customers by a merchant. The system enables processing of the electronic transactions by using transaction codes stored in the system, instead of storing financial information provided by a customer. As a consequence of not storing the financial information of the customer, the system helps to reduce the merchant's involvement in ensuring that the financial information of the customer is secure from frauds.

Further, since the transaction codes that contain the financial information are stored in the system, cardless processing of the electronic transactions is enabled. Furthermore, the system enables the merchant to reconcile the electronic transactions that have been processed by the customers, automatically from within the system itself. Still further, the system enables the reduction of a transaction processing fee charged to the merchant by a financial network for processing the electronic transactions by using batch processing. The system is also designed so as to integrate secure processing of the electronic transactions into existing proprietary electronic transaction systems, without requiring the merchant to invest in additional infrastructure for ensuring secure processing of the electronic transactions.

As explained in conjunction with FIG. 5, the various modules of the system may be implemented as a software application product for processing electronic transactions for customers. It will be evident to those skilled in the art that the merchant may log on to a website hosting the software application or may have the software application embodied in a physical device such as a Compact Disc (CD), a Read Only Memory (ROM), and the like, and may install the program from the physical device. Further, the installation may include standard procedures such as inputting license details, loading menu options and the like. Further, the merchant may need to update the software application to a newer version developed by a software vendor in order to fix bugs in the software application, or to configure an added functionality in the software application. The merchant may install a newer version of the program by logging on to a website hosted by the software vendor or by a third party. The program may also have a help menu for the merchant to assist in operating the program. Further, other information regarding system support required for operating the program may also be available to the merchant.

As described above, the embodiments of the disclosure may be embodied in the form of computer-implemented processes and apparatuses for secure processing of electronic transactions. Embodiments of the disclosure may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the disclosure. The present disclosure may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the disclosure. When implemented on a general-purpose microprocessor, the computer program code segments configure the microprocessor to create specific logic circuits.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present invention.

What is claimed is:

1. A method for providing secure processing of electronic transactions for customers, each customer maintaining at least one payment account for use in the electronic transactions, the method comprising:
processing a first electronic transaction for a customer, wherein the first electronic transaction is processed using a payment account of the at least one payment account of the customer;
generating a transaction code for the first electronic transaction, the transaction code capable of identifying the payment account used for processing the first electronic transaction; and
processing a second electronic transaction for the customer using the transaction code, wherein the transaction code is used to process the second electronic transaction on selection of the payment account by the customer,
wherein a transaction code is generated for each electronic transaction subsequent to the first electronic transaction, and,
wherein each transaction code is used to process an electronic transaction processed subsequent to the generation of the each transaction code on selection of the payment account by the customer, and,
wherein processing the electronic transactions using transaction codes provides secure processing of the electronic transactions.

2. The method of claim 1, wherein the each transaction code identifies a payment gateway used for processing an electronic transaction associated with the each transaction code.

3. The method of claim 1, wherein each transaction code includes a pre-determined number of digits of the payment account for identifying the payment account.

4. The method of claim 1, wherein each transaction code is generated from a payment gateway code, the payment gateway code generated by a payment gateway uniquely identifying each electronic transaction processed through the payment gateway.

5. The method of claim 1, further comprising receiving customer identification information from the customer for identifying the customer prior to processing the each electronic transaction subsequent to the first electronic transaction.

6. The method of claim 5, wherein the customer identification information comprises at least one of a customer name and a customer company name.

7. The method of claim 1, further comprising pre-validating the payment account prior to processing an electronic transaction.

8. The method of claim 1, further comprising identifying transaction invoices for the each electronic transaction subsequent to the first electronic transaction prior to processing the each electronic transaction for the customer, each transaction invoice of the transaction invoices associated with an electronic transaction of the each electronic transaction.

9. The method of claim 8, further comprising grouping the transaction invoices for the customer into one transaction invoice prior to processing the each electronic transaction subsequent to the first electronic transaction.

10. The method of claim 1, further comprising storing the transaction codes for processed electronic transactions.

11. The method of claim 10, further comprising retrieving payment gateway codes of settled transactions from a payment gateway to compare the stored transaction codes with the retrieved payment gateway codes of settled transactions for a match.

12. The method of claim 11, further comprising comparing a transaction code of the stored transaction codes that corresponds to an electronic transaction to be reversed with the retrieved payment gateway codes of settled transactions for a match.

13. The method of claim 12, further comprising transmitting a control signal to the payment gateway on occurrence of the match, the control signal transmitted to the payment gateway for reversing a charge made to the payment account of the customer.

14. The method of claim 11, further comprising comparing a transaction code of the stored transaction codes that corresponds to an electronic transaction to be nullified with the retrieved payment gateway codes for settled transactions for a match.

15. The method of claim 14, further comprising transmitting a control signal to the payment gateway on occurrence of the match, the control signal transmitted to the payment gateway for nullifying a charge made to the payment account of the customer.

16. A system for providing secure processing of electronic transactions for customers, each customer maintaining at least one payment account for use in the electronic transactions, the system comprising:
a data entry module capable of receiving a selection of a payment account of the at least one payment account of a customer for processing an electronic transaction of the electronic transactions;
a network interface module configured to communicate with a payment gateway, the network interface module capable of receiving the selection of the payment account from the data entry module for communicating payment account information to the payment gateway; and
a code generator module capable of communicating with the network interface module for generating a transaction code for each electronic transaction,
wherein each transaction code identifies the payment account used for processing the electronic transactions, and
wherein processing the electronic transactions using transaction codes provides secure processing of the electronic transactions.

17. The system of claim 16, further comprising a memory module capable of storing the transaction codes.

18. The system of claim 17, further comprising a comparator module configured to compare the transaction codes stored in the memory module with a list of payment gateway codes of settled transactions retrieved from the payment gateway by the network interface module for a match.

19. The system of claim 16, wherein the data entry module is capable of receiving one of an electronic card data and a biometric data associated with the payment account of the customer.

20. A computer program product embodied on a computer readable medium for providing secure processing of electronic transactions for customers, each customer maintaining at least one payment account for use in the electronic transactions, the computer program product comprising a program module having instructions for:
processing a first electronic transaction for a customer, wherein the first electronic transaction is processed using a payment account of the at least one payment account of the customer;
generating a transaction code for the first electronic transaction, the transaction code capable of identifying the payment account used for processing the first electronic transaction; and
processing a second electronic transaction for the customer using the transaction code, wherein the transaction code is used to process the second electronic transaction on selection of the payment account by the customer,
wherein a transaction code is generated for each electronic transaction subsequent to the first electronic transaction, and,
wherein each transaction code is used to process an electronic transaction processed subsequent to the generation of the each transaction code on selection of the payment account by the customer, and,
wherein processing the electronic transactions using transaction codes provides secure processing of the electronic transactions.

21. The computer program product according to claim 20, further comprising instructions for receiving customer identification information from the customer for identifying the customer prior to processing the each electronic transaction subsequent to the first electronic transaction for the customer.

22. The computer program product according to claim 20, further comprising instructions for pre-validating the payment account prior to processing an electronic transaction.

23. The computer program product according to claim 20, further comprising instructions for identifying transaction invoices for the each electronic transaction subsequent to the first electronic transaction prior to processing the each electronic transaction for the customer, each transaction invoice of the transaction invoices associated with an electronic transaction of the each electronic transaction.

24. The computer program product according to claim 23, further comprising instructions for grouping the transaction invoices for the customer into one transaction invoice prior to processing the each electronic transaction subsequent to the first electronic transaction.

25. The computer program product according to claim 20, further comprising instructions for storing the transaction codes for processed electronic transactions.

26. The computer program product according to claim 25, further comprising instructions for retrieving payment gateway codes of settled transactions from a payment gateway to compare the stored transaction codes with the retrieved payment gateway codes of settled transactions for a match.
